(19) United States
(12) Patent Application Publication
(10) Pub. No.: US 2010/0139138 A1
(43) Pub. Date: Jun. 10, 2010

(54) MULTI-PURPOSE AUXILIARY MEMBER FOR USE WITH PERSONAL CARDS

(75) Inventor: John B. Miadich, Lake Oswego, OR (US)

Correspondence Address: The Law Office of Jane K. Babin;Professional Corporation, c/o Intellevate, P.O. Box 52050, Minneapolis, MN, 55402, US

(73) Assignee: CARDWARE, LLC., Lake Oswego, OR (US)

(21) Appl. No.: 12/623,415

(22) Filed: Nov. 21, 2009

Related U.S. Application Data
(63) Continuation-in-part of application No. 11/888,960, filed on Aug. 3, 2007, now abandoned.

(51) Int. Cl. B42F 21/00; G09F 3/00

(52) U.S. Cl. 40/641

(57) ABSTRACT

The present invention provides multipurpose a multi-purpose auxiliary member for use with a personal card that may be carried in a card carrying case having at least one compartment. The multi-purpose auxiliary member includes at least one attachment component attachable to an edge portion of the personal card and at least one extension component. Technology may be associated with either an attachment component and/or an extension component. In particular, the present invention provides a personal card removal tool multi-purpose auxiliary member that can be used secure a personal card and remove the personal card from a card carrying case.

### RELATED APPLICATIONS

This application is a continuation-in-part of U.S. application Ser. No. 11/888,960, the entire disclosure of which is incorporated herein by reference.

### FIELD OF THE INVENTION

The present invention is directed to a multi-purpose auxiliary member for use with “personal cards” in a card carrying case, a plurality of the multi-purpose auxiliary members being used together to form an auxiliary member system for organizing a card carrying case.

In modern society, wallets or card carrying cases are stuffed with a multitude of cards of all types. For example, there are identification cards (e.g. driving licenses, ID cards, membership cards, access cards, book club cards, and/or library cards) that help others identify the bearer. There are payment cards (e.g. credit cards, debit cards, and/or calling cards) for making payments. There are promotional cards (e.g. gift cards, loyalty cards, discount cards, business cards, airline travel cards, and/or movie rental cards) that are handed out, bought, and/or collected for the purpose of promoting a business or a business relationship. There are photographs that, although not truly “cards,” are often carried in a card carrying case as sort of “loved-one” cards. For purposes of simplicity, these and other similar card carrying case items will be referred to herein generally and/or jointly as “personal cards,” “cards,” and/or “personal card collections.” These personal cards typically have a longitudinal length of between 3 inches (7.5 cm) and 3.75 inches (9.5 cm), a width of between 1.7 inches (4.3 cm) and 2.8 inches (9.6 cm), and a thickness between 0.015 inches (0.46 mm) and 0.03 inches (0.76 mm).

Most people carry some kind of wallet, billfold, small pouch, or other holder (hereinafter referred to generally as “card carrying case”) as a convenient means for carrying, organizing, and gaining ready access to particular cards. To this end, card carrying cases tend to have at least one pouch, pocket, and/or slot (referred to generically as “compartments”) to display a personal card collection. The terms “pouch,” “pocket,” and “slot” describe similar structures in that they are all suited to holding cards, although for purposes of this description, a pouch may be designed to hold more cards than a pocket and a pocket may be designed to hold more cards than a slot. A plurality of compartments may be offset from one another such that a portion of each card is viewable as a cue for the owner to identify the card. The compartments may be oriented to display a long edge portion or a short edge portion of the cards of a personal card collection. In most cases, because only a small portion of a card is exposed from a compartment, there is little surface area by which the card can be grasped. This makes it difficult for fingers and/or fingernails to grasp. The problem is compounded by the often slick surfaces (e.g. plastic) of these cards, and the fingers/fingernails tend to slip from the card when trying to withdraw a card. By necessity, slots tend to be tight so as to securely hold the personal cards. The tight slots make it even more difficult to remove a card from a slot. Further, it is not uncommon for people to stuff multiple cards in a single, already tight slot, thereby making it even more difficult to remove the card or cards. Still further, some card carrying cases have one or more specialized pockets and/or slots with a window through which a frequently used card (e.g. an identification card) can be viewed. For security purposes, the specialized pocket and/or slot may be especially deep so that the frequently used card is positioned completely within the specialized pocket and/or slot without an exposed edge. A deep pocket and/or slot makes it especially difficult to grasp the “outermost” edge of the frequently used card.

As mentioned, in modern society, card carrying cases can be stuffed with a multitude of cards of all types. Depending on the layout of the card carrying case and the number of cards, a user may not be able to see any cards, only one card, or a few cards of his personal card collection. This means that the user is often left to memorizing the placement of the non-viewable cards. If the card is returned to the wrong spot in the card carrying case, panic can ensue until the missing card is located. In extreme cases, finding a desired card may require the removal of most, if not all of the cards in a card carrying case.

Continued access, removal, and reinsertion of cards into and out of card carrying case pockets and/or slots can be inconvenient, difficult, and perhaps can even result in undesired wear and tear on both the card carrying case and the cards.

Although some cards are made of hard plastics or are “ruggedized” to some extent, others are not. More delicate cards can tear from repeated removal and reinsertion. The pockets and/or slots in the card carrying case can be stretched or torn from repeated removal and reinsertion. One characteristic shared by many personal cards is that they have information thereon. Many personal cards have text or numbers to identify the user printed or stamped (e.g. raised numbers) thereon. Many personal cards have information to identify the issuing source or other pertinent information thereon. Some personal cards have information stored thereon in a magnetic stripe (for example, membership cards, access cards, credit cards, debit cards, and/or gift cards). Some cards have IC chips (or other electronics) integral therewith that provide the cards with extra capabilities. Some personal cards are punched or otherwise marked (e.g. loyalty cards and/or discount cards). The magnetic stripes, electronics, and markings can also be damaged by repeated removal and reinsertion.

In an attempt to reduce the clutter of card carrying cases, some personal cards are being replaced with smaller versions that have a hole defined therein and are meant to be carried on a key fob. For purposes of simplicity, these smaller versions will be referred to herein generally as “fob cards.” These fob cards typically have a longitudinal length of between 1.7 inches (4.5 cm) and 2.2 inches (5.5 cm) and a width of between 7.8 inches (2 cm) and 1.2 inches (3 cm).

### SUMMARY OF THE INVENTION

One embodiment of the present invention provides a multi-purpose auxiliary member for use with a personal card that may be carried in a card carrying case having at least one compartment. The multi-purpose auxiliary member includes at least one attachment component attachable to an edge portion of the personal card and at least one extension component. The at least one extension component extends beyond the outermost annular edge when the at least one attachment component is attached to the edge portion of the personal card.

Another embodiment of the present invention provides an auxiliary member system for use in a card carrying case having at least one compartment. The system includes a plurality of personal cards and a plurality of multi-purpose auxiliary members. Each multi-purpose auxiliary member attached to a personal card such that the extension component extends beyond the outermost annular edge of the personal card.

Yet another embodiment of the present invention provides a multi-purpose auxiliary member that includes technology associated with either an attachment component and/or an extension component.

In still further embodiments, the present invention provides a multi-purpose auxiliary member that is a tool for removing a personal card from a card carrying case. Such multi-purpose auxiliary member tools include an attachment component that is a generally a flattened body having a generally planar top card gripping arm and a generally planar bottom card gripping arm extending distally from a common base such that the top gripping arm and bottom gripping arm are opposed and held in a generally parallel orientation to each other, the top gripping arm and the bottom gripping arm together defining a card slot having an open front end and a closed back end, the card slot being adapted to removably accept and secure a personal card by tight friction fit; and an extension component disposed upon and extending distally from the base of the attachment component, said extension component being adapted for gripping and removal a personal card from a card carrying case when the tool is secured to the personal card.

In certain aspects of the multi-purpose auxiliary member tool, the attachment component is a single unit that is made of rigid metal, plastic or a combination of metal and plastic. Such attachment components can be manufactured, for example, by metal injection molding.

In certain aspects, the back end of the card slot is narrower than the front end of the card slot, the card slot being tapered from back to front. For example, the back end of the card slot can be about 0.30 mm to about 0.90 mm wide and the front end of the card slot is about 0.40 mm to about 1.00 mm wide. In other aspects, the card slot is stepped, having a narrower region adjacent to the back end that is adapted to secure a thin personal card, and a wider region adjacent to the front opening that is adapted to secure a thick personal card. For example, the narrower region of the card slot can be about 0.30 mm to about 0.55 mm wide and the wider region of the card slot is about 0.55 mm to about 1.00 mm wide. In certain embodiments, the stepped card slot can accommodate two personal cards.

The top gripping arm and bottom gripping arm of the multi-purpose auxiliary member tool generally can have a generally rectangular or circular shape, or any shape that is desired. Optionally, the attachment component can include an arm adapted to secure the tool in a card carrying case.

In certain aspects, the extension component is hingeably attached to the base of the attachment component. Furthermore, the extension component can be adapted to rotate about the hinge from a closed position in which the extension component lies flat upon the attachment component, to an open position where the extension component is perpendicular to the closed position. In other aspects of the invention, the extension component is immovably attached to the base of attachment component. In certain embodiments, the extension component is a continuation of a design element of the attachment component.

To assist in gripping the tool, the extension component can include a ridge disposed on an outer surface of the attachment component. The extension component can include such materials as metal, leather, plastic, and/or glass. In certain embodiments, the extension component can also includes a decoration such as paint, enamel, embossing, engraving or a stone.

In yet further embodiments, the tool can include a magnetic stripe, a semiconductor chip device, an integrated circuit device, a radio frequency identification tag device or a bar code.

Also provided is a multi-purpose auxiliary member tool for securing and removing at least two personal cards from a card carrying case that includes an attachment component that is a generally flattened body having at least one generally planar top card gripping arm and at least one generally planar bottom card gripping arm, each card gripping arm extending distally from a common base such that the at least one top card gripping arm and the at least one bottom card gripping arm are opposed and held in a generally parallel orientation to each other, the at least one top gripping arm and the at least one bottom gripping arm together defining at least two card slots each card slot having an open front end and a closed back end, the at least two card slots being adapted to removably accept and secure a personal card by tight friction fit; and an extension component disposed upon and extending distally from the base of the attachment component, said extension component being adapted for gripping and removal of the at least two personal cards from a card carrying case when the tool is secured to the at least two personal cards. In certain aspects of this embodiment, the multi-purpose auxiliary member tool includes a first card slot and a second card slot, such that the bottom card gripping arm of the first card slot is coextensive with the top card gripping arm of the second card slot. In certain aspects, the at least two card slots are staggered.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1 is a front view of a personal card collection showing multi-purpose auxiliary members of the present invention attached to cards of the collection in a pouch of a card carrying case.

FIG. 2 is a perspective view of a personal card collection with multi-purpose auxiliary members of the present invention attached thereto, in pockets offset from one another, the cards being oriented such that the long edge portion is exposed, and a single card with a multi-purpose auxiliary member is in a specialized pocket and/or slot.

FIG. 3 is a plan view of a personal card collection with multi-purpose auxiliary members attached to the cards thereof, in slots offset from one another, the cards being oriented such that the short edge portion is exposed, and a single card with a multi-purpose auxiliary member in a specialized pocket and/or slot.

FIG. 4 is a front view of a first embodiment of a multi-purpose auxiliary member having two attachment components and a bent or bendable extension component being attached to a card.

FIG. 5A is a plan view of a second embodiment of a multi-purpose auxiliary member having an adjustable two-attachment component and a customizable extension component.

FIG. 5B is a side view of the second embodiment of a multipurpose auxiliary member of FIG. 5A being attached to a card such that the multi-purpose auxiliary member will be positioned so that a second score or guide line will be aligned with the edge of the card.

FIG. 5C is a side view of the second embodiment of a multipurpose auxiliary member of FIG. 5A being attached to a card such that the multipurpose auxiliary member will be positioned so that a first score or guide line will be aligned with the edge of the card.

FIG. 6A is a front view of a third embodiment of a multi-purpose auxiliary member having a single narrow attachment component and a multi-orientation and three-dimensional extension component, a design element of the extension component having a first orientation.

FIG. 6B is a side view of the third embodiment of a multipurpose auxiliary member of FIG. 6A.

FIG. 6C is a back view of the third embodiment of a multipurpose auxiliary member of FIG. 6A, a design element of the extension component having a second orientation.

FIG. 7A is a perspective view of a fourth embodiment of a multipurpose auxiliary member attached to a card, this embodiment having an edge attachment component and a writable surface extension component.

FIG. 7B is a side view of the fourth embodiment of the multi-purpose auxiliary member of FIG. 7A attached to a card.

FIG. 8 is a side view of a fifth embodiment of a multi-purpose auxiliary member being attached to a card, this embodiment having a mechanical gripping attachment component and a thickset extension component.

FIG. 9A is a side view of a sixth embodiment of a multi-purpose auxiliary member being attached to a card, this embodiment having a mechanical through-card attachment component and a two-part extension component.

FIG. 9B is a front view of the sixth embodiment of the multipurpose auxiliary member of FIG. 9A attached to a card.

FIG. 9C is a back view of the sixth embodiment of the multi-purpose auxiliary member of FIG. 9A attached to a card.

FIG. 10A is a front view of a seventh embodiment of the multipurpose auxiliary member attached to a card, the multi-purpose auxiliary member being in an expanded position, this embodiment having a spring-loaded attachment component and a retractable passaged extension component.

FIG. 10B is a front view of the seventh embodiment of the multi-purpose auxiliary member of FIG. 10A in a contracted position.

FIG. 11A is a side view of a card removal tool embodiment multi-purpose auxiliary member.

FIG. 11B is a top perspective view of the card removal tool embodiment multi-purpose auxiliary member shown in FIG. 11A.

FIG. 11C is a top view of the card removal tool embodiment multi-purpose auxiliary member shown in FIG. 11A.

FIGS. 12A and 12B illustrate the insertion of a personal card into the card removal tool of FIG. 11A. FIG. 12A shows the card removal tool aligned with a personal card prior to insertion. The arrow indicates the direction of insertion. FIG. 12B shows the tool with the personal card inserted.

FIG. 12C is a side view of the card removal tool embodiment of the multi-purpose auxiliary member shown in FIG. 12A with the extension component rotated at the hinge.

FIG. 13A is a top view of an embodiment of a card removal tool multi-purpose auxiliary member having a finger-grip ridge grippable element.

FIG. 13B is a side perspective view of the card removal tool multi-purpose auxiliary member shown in FIG. 13A.

FIGS. 14A-14F show a card removal tool multi-purpose auxiliary member with a stepped card slot.

FIGS. 14A-14D illustrate the insertion of thin and thick personal cards into a card removal tool having a stepped card slot. FIG. 14A shows the card removal tool aligned with a thin personal card. The arrow indicates the direction of insertion. FIG. 14B shows the tool with the thin personal card inserted. FIG. 14C shows the card removal tool aligned with a thick personal card. The arrow indicates the direction of insertion. FIG. 14D shows the tool with the thick personal card inserted.

FIGS. 14E and 14F illustrate the insertion of two personal cards into a card removal tool having a stepped card slot. FIG. 14E shows the card removal tool aligned with two personal cards. The arrows indicate the direction of insertion. FIG. 14F shows two personal cards inserted into the single stepped card slot.

FIGS. 15A-15F illustrates an embodiment of a personal card removal tool multipurpose auxiliary member having a clamshell type extension component. FIG. 15A is a top perspective view of the personal card removal tool with the extension component closed. FIG. 15B is a back view of the card removal tool of FIG. 15A with a personal card inserted into the card slot. FIG. 15C is a side view of the card removal tool of FIG. 15A with a personal card inserted into the card slot. In this view, the extension component has been removed for clarity. FIG. 15D is a top view of the card removal tool of FIG. 15A. In this view, a personal card is inserted into the card slot of the tool and the card is contained within the pocket of a wallet and the extension component is closed over the leather pocket to secure the card in the pocket. FIG. 15E shows the card removal tool of FIG. 15A attached to a person card that is partially removed from a window type pocket of a wallet card carrying case. In this view, the extension component has been opened to a 90 degree position relative to the attachment component to allow gripping of the tool and to facilitate removal of the card from the window pocket. FIG. 15F is a top perspective view of the card removal tool of FIG. 15A with the extension component opened even further than in FIG. 15E. This position may be useful for inserting the card into the card slot of the tool.

FIGS. 16A-16E illustrate an embodiment of a personal card removal tool multipurpose auxiliary member that includes an optional a wallet clip. FIG. 16A is a top view of the personal card removal tool on top of a wallet and positioned to secure a personal card that is seated in a window pocket of the wallet. FIG. 16B is a cross-sectional view of the card removal tool and wallet shown in FIG. 16A. FIG. 16C a cross-sectional view of the card removal tool of FIG. 16A at an initial, alignment stage of attachment to the personal card. In this view, the top surface of the leather has been separated from the card by action of the tool and the personal card has been partially inserted in to the tool's card slot. FIG. 16D is a cross-sectional view of the card removal tool of FIG. 16A with the card and wallet pocket window member fully engaged by the tool. FIG. 16E is a top view of the card removal tool fully engaging a personal card and wallet pocket window member.

FIG. 17 shows the top views of ten nonlimiting examples of card removal tools (A-J), each attached to a personal card, that illustrate the variety of attachment components, extension components and attachment positions for the tools. FIG. 17A is a tool having a rectangular attachment component with fingernail pick gripping feature extension component. FIG. 17B is a tool having a round attachment component with a hinged strap extension component. FIG. 17C is a tool having a round attachment component with a decorative extension component attached directly to the extension component. FIG. 17D is a tool having a round attachment component with a chain loop extension component attached directly to the attachment component. FIG. 17E is a tool with a round attachment component attached to a side edge of the personal card, and having a fingernail grip ridge extension component. FIG. 17F is a tool with a round attachment component attached to a corner edge of the personal card, and having a polygonal loop extension component. FIG. 17G is a tool with at flower-shaped, decorative attachment component having a loop extension component. FIG. 17 H is a tool in which the extension component is integral to the attachment component. The extension component of tool of FIG. 17 H extends distally from the attachment component to provide a grippable element that can be grasped for removal of the personal card. The tool of FIG. 17 H, which is attached to the long edge of a personal card, illustrates certain aspects of decorated tools, e.g. painting and jewels. The tool of FIG. 17 I illustrates additional decorative elements including an embossed attachment component and a jeweled extension component strap. The tool of FIG. 17J has a rectangular attachment component and a clamshell extension component. The tools of FIGS. 17A-C and G-I are each attached to a long edge of the personal card; the tools of FIGS. 17D, E and J are each attached to a short edge of the personal card; and the tool of FIG. 17F is attached to a corner edge of the personal card.

### DETAILED DESCRIPTION

### Definitions

The term “about” as used herein means that a number referred to as “about” comprises the recited number plus or minus 1-10% of that recited number. For example, “about” 100 inches can mean 95-105 inches or as few as 99-101 inches depending on the situation. Whenever it appears herein, a numerical range such as “1 to 20” refers to each integer in the given range; e.g., “1 to 20 mm” means that a measurement can be 1 mm, 2 mm, 3 mm, etc., up to and including 20 mm. Similarly, ranges that include numbers with decimal places include each number in the given range signified by given decimal places, e.g., “0.30 mm to 0.40 mm” includes 0.30 mm, 0.31 mm, 0.32 mm, 0.34 mm, 0.35 mm, 0.36 mm, 0.37 mm, 0.38 mm, 0.39 mm, and 0.40 mm.

A “personal card,” as used herein, refers to a small card that can be retained in a wallet, billfold or card organizer that is carried on or by a person, containing information about or used by a person. Personal cards, as used herein, are between 2.5 inches (6.35 cm) and 4 inches (10.16 cm) long; between 1.5 inches (3.81 cm) and 3 inches (10.16 cm) wide; and between 0.01 inches (0.254 mm) and 0.04 inches (1 mm) thick. In certain embodiments, personal cards are between 3 inches (7.5 cm) and 3.75 inches (9.5 cm) long; between 1.7 inches (4.3 cm) and 2.8 inches (9.6 cm) wide; and between 0.015 inches (0.46 mm) and 0.03 inches (0.76 mm) thick.

The information that can be contained in or on a personal card includes typed or written information; photographic information (e.g. a picture of the person); coded information (e.g. bar-coded information); electronically recorded information (e.g. information recorded on a magnetic stripe or integrated circuit); and embossed or imprintable information (e.g. transferable by credit card imprinting device). The information contained in or on a personal card maybe of a permanent or “read-only” type, or it may be editable or re-writable information.

Personal cards are typically made from plastic but can be made from or include other materials such as coated or laminated card stock and metal, and can include additional components such as integrated circuits and magnetic stripes. The type of material that the card is made from depends in part on the information contained in or on the personal card. Thus, for example, a personal card containing information recorded electronically on a magnetic stripe will typically made from at material that will protect the stripe, yet permit the swiping of the stripe to “read” the information. Similarly, a personal card containing information recorded electronically on an integrated circuit must be made of a material that will protect the integrated circuit from damage due to handling, but also be sufficiently transmissive to permit interaction of the integrated circuit with a mated device capably of reading the information stored therein.

In certain aspects of the invention, a personal card is a standard identification card conforming to ISO/IEC standard 7810:2003, including standard ID-000 cards, standard ID-1 cards, standard ID-2 cards and standard ID-3 cards. Personal cards also include proximity cards that conform to ISO/IEC standard 14443-1:2008. “Proximity cards” as used herein, refers to cards used to control access, authentication and integrity validation, such as cards that are read by a detection device to open doors, gates and the like. Proximity cards employ contactless-detection technology and typically include an integrated circuit, such as a Radio-frequency identification (RFID) tags. Personal cards also include contactless integrated circuit identification cards conforming to ISO/IEC standard 15693-1:2000, known as “vicinity cards”.

Personal cards also include diving licenses, particularly ISO-compliant driving licenses conforming to ISO/IEC standard 18013-1:2005. Thin flexible cards conforming to ISO/IEC standard 15457-1:2008 are also included in the definition of personal cards.

“Financial transaction cards” are also included in the definition of personal cards. Such cards include credit cards, debit cards, other bank cards, loyalty cards (e.g. merchant loyalty cards) and the like, that contain a magnetic stripe capable of storing and transmitting information. Financial transaction cards include those that conform to one or more of standards ISO 9992, ISO/IEC 7813 and ISO/IEC 4909.

As used herein, “card carrying case” refers to a wallet, billfold, organizer, clutch or other case designed to hold personal cards, and in particular adapted for holding driver's licenses and credit cards. Also included in the definition of card carrying case are briefcases, backpacks, handbags, purses, fanny packs, valises and the like, that include pockets, slots or other adaptations for holding personal cards.

“Tight friction fit,” “friction fit” and “interference fit” are used interchangeably to refer to the perfect fit fastening between two mated parts, such as a personal card and the card slot an attachment component of a personal card removal tool of the invention adapted to accept the personal card. Tight friction fit fastening is achieved by friction after the parts are pushed together, rather than by any other means of fastening. The friction that holds the parts together is often greatly increased by compression of one part against the other, which relies on the tensile and compressive strengths of the materials the parts are made from. An interference fit is generally achieved by shaping one or the other of two mating parts so that one or the other (or both) slightly deviate in size from the nominal dimension. The word interference refers to the fact that one part slightly interferes with the space that the other is taking up. The skilled artisan will appreciate that variations in the “allowance” (planned difference from nominal size) between two mated parts that will result in various strengths of fit such as loose fit, light interference or light friction fit, and interference or tight friction fit. The value of the allowance depends on which material is being used, how big the parts are, and what degree of tightness is desired.

In certain embodiments of the invention described herein, the card slot of an attachment component of a multipurpose auxiliary member is mated to a personal card to achieve a tight friction fit between the two at one or more point in the card slot (described below). The tight friction fit is sufficient to secure the card within the card slot of the multipurpose auxiliary member through repeated insertion and removal in a card carrying case, but not so tight as to prevent removal of the card from the multipurpose auxiliary member when desired.

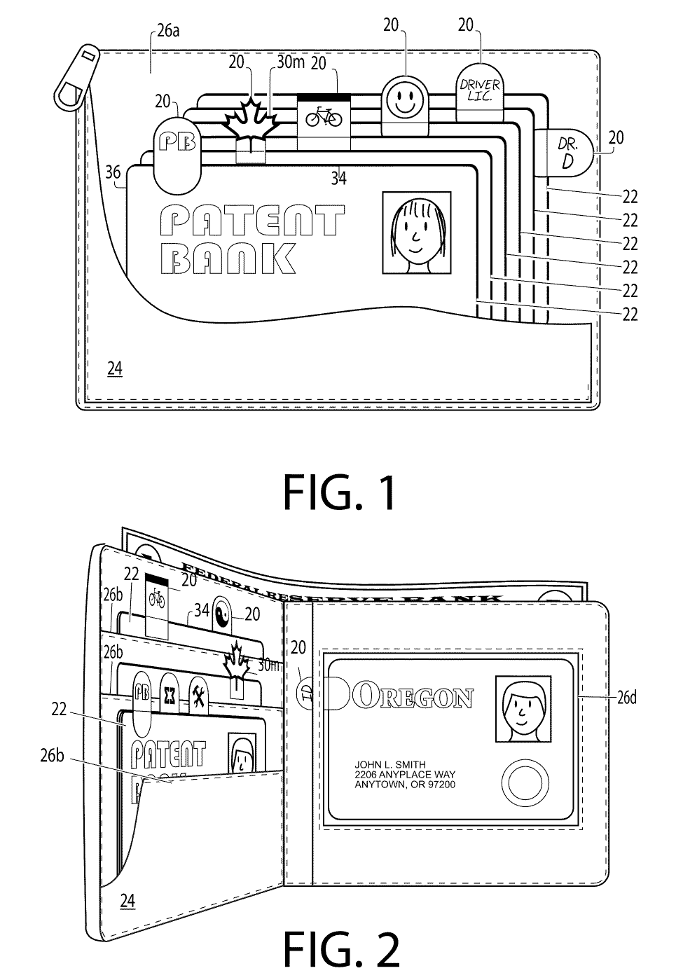

As shown in FIGS. 1-17, the present invention is directed to a multipurpose auxiliary member (referred to generally with reference numeral 20) for use with “personal cards,” as defined above, and/or “personal card collections” (all referred to generally with reference numeral 22) that may be carried in a wallet or similar card carrying case 24 having at least one compartment 26. A plurality of the multipurpose auxiliary members 20 can be used together to form an auxiliary member system.

FIGS. 1-3 show personal card collections 22 with multi-purpose auxiliary members 20 in compartments 26 (shown as pouches 26a, pockets 26b, slots 26c, and/or specialized pockets and/or slots 26d, including slots with windows) of exemplary card carrying cases 24. For example, FIG. 1 shows a personal card collection 22 with multi-purpose auxiliary members 20 in a pouch 26a of an exemplary card carrying case 24. FIG. 2 shows an exemplary card carrying case 24 with a personal card collection 22, at least one card 22 of which has a multi-purpose auxiliary member 20. The exemplary card carrying case 24 of FIG. 2 has pockets 26b offset from one another, the cards 22 being oriented such that the long edge portion 34 (or just the long edge itself) is exposed. FIG. 3 shows an exemplary card carrying case 24 with a personal card collection 22, at least one card 22 of which has a multi-purpose auxiliary member 20. The exemplary card carrying case 24 of FIG. 3 has slots 26c offset from one another, the cards 22 being oriented such that the short edge portion 36 (or just the short edge itself) is exposed. The exemplary card carrying cases 24 shown in FIGS. 2 and 3 also include a specialized pocket and/or slot 26d in which a single card 22 with a multi-purpose auxiliary member 20 may be inserted.

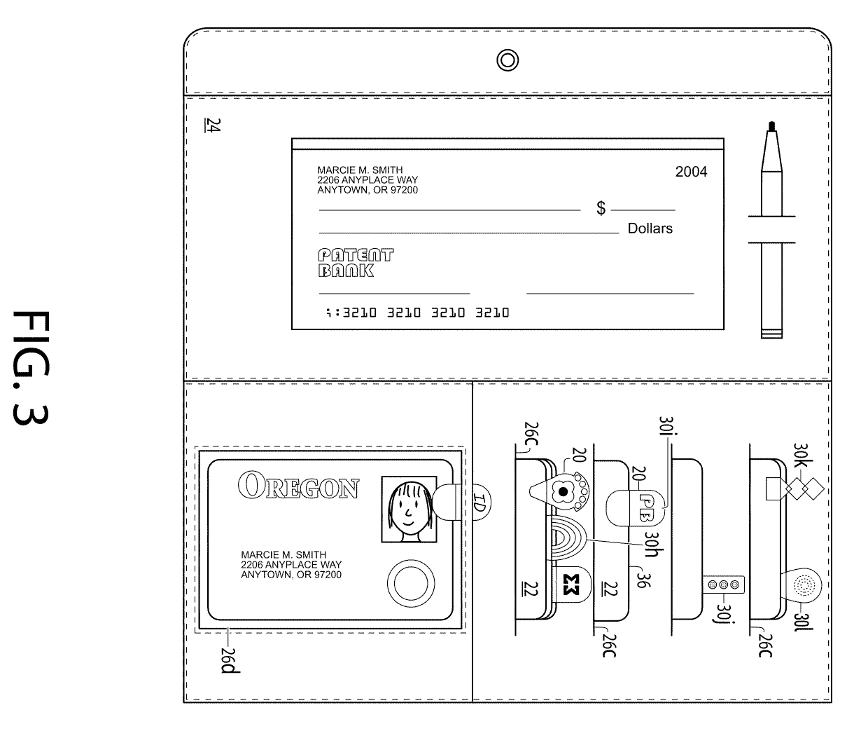

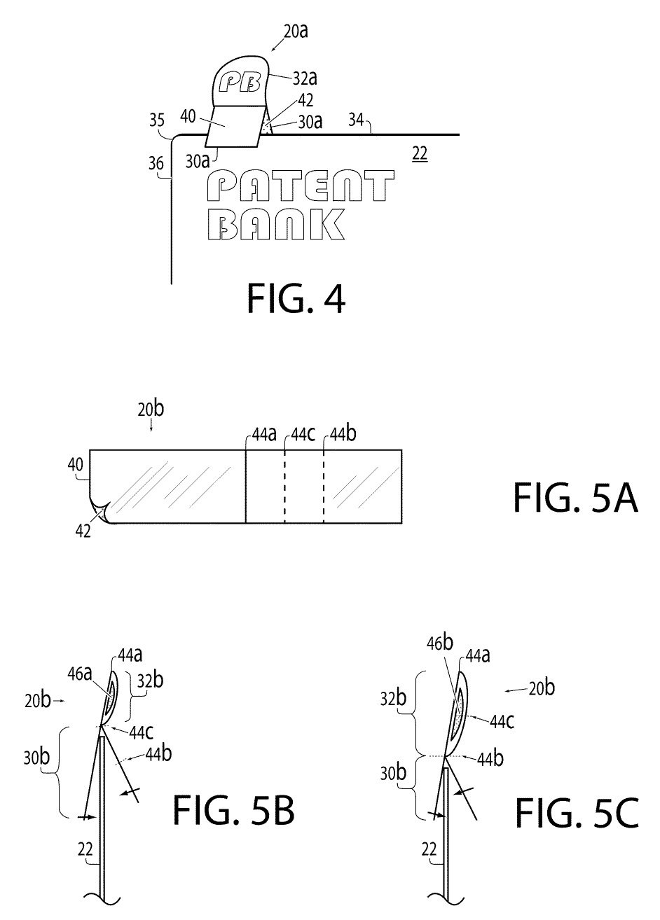

FIGS. 4, 5A-5C, 6A-6C, 7A-7B, 8, 9A-9C, and 10A-10B show exemplary embodiments of a multi-purpose auxiliary member 20 (labeled specifically as multi-purpose auxiliary members 20a-20g). The multi-purpose auxiliary members 20 each have two components: at least one attachment component 30 and at least one extension component 32. The attachment component 30 is designed to attach to any edge portion (e.g. a long edge portion 34, a corner edge portion 35, or a short edge portion 36) of a card 22. It should be noted that the term “edge portion” 34, 35, 36 is meant to include all or part of the outermost annular edge (e.g. the annular perimeter) as well as the front surface and/or back surface of the card 22 substantially adjacent to (e.g. within approximately 0.75″ (2 cm)) the outermost annular edge. When the attachment component 30 is attached to an edge portion of a card 22, the extension component 32 extends beyond the outermost annular edge of the card 22, can be extended beyond the outermost annular edge of the card 22, or extends beyond the surface of the card 22.

### Attachment Component 30

As set forth above, the at least one attachment component 30 is adapted to attach to any edge portion (e.g. a long edge portion 34, a corner edge portion 35, or a short edge portion 36) of a personal card 22. This is a significant feature of the present invention because each card carrying case 24 is unique. Some card carrying cases 24 have compartments 26 in which cards 22 are oriented such that the long edge portion 34 (or just the long edge itself) is exposed (see FIGS. 1 and 2). Some card carrying cases 24 have compartments 26 in which cards 22 are oriented such that the short edge portion 36 (or just the short edge itself) is exposed (see FIG. 3). Some card carrying cases 24 have compartments 26 in which cards 22 may be oriented such that some cards 22 have the short edge portion 36 (or just the short edge itself) exposed; other cards 22 have the long edge portion 34 (or just the long edge itself) exposed; while still other cards 22 have only a corner edge portion 35 (or just the corner itself) exposed. Some card carrying cases 24 (e.g. those having a specialized pocket and/or slot 26d) have no edges exposed. Accordingly, having the at least one attachment component 30 adapted for attachment to any edge portion 34, 35, 36 of a card 22 is one of the features of the present invention. It should be noted that the showing of an exemplary embodiment of a particular multi-purpose auxiliary member 20 attached to one type of edge portion 34, 35, 36 is not meant to limit the multi-purpose auxiliary member 20 to being attached only to that type of edge portion 34, 35, 36. The attachment component 30 can best be described as including a carrier 40 and an attachment mechanism 42. The carrier 40 may be made of any material including, but not limited to paper (e.g. card stock and/or cardboard), plastic, velum, fabric, metal (e.g. precious metals or non-precious metals), leather, stone, wood, plastic, rubber, or any material or combination of materials that is relatively thin. It should be noted that the intended use may influence the choice of material. For example, if there is a possibility that the attachment component 30 will cover important features of a personal card 22 (e.g. raised and/or printed text, raised and/or printed numbers, photos, and/or logos), it may be desirable to use a very thin (e.g. between 0.0003″ (0.01 mm) and 0.0295″ (0.75 mm)) and/or transparent material for the carrier 40. Using a very thin material for the carrier 40 would also be advantageous in that it would not add bulk to a personal card collection 22. Still another advantage of using a very thin material for the carrier 40 would also be that it would not interfere with the use of a card's magnetic stripe (although thicker materials could be used if they did not interfere). The attachment mechanism 42 may be, for example, an adhesive (e.g. a traditional adhesive coating 42 or an alternative adhesive 42′), a mechanical attachment mechanism 42″ (e.g. a mechanical gripping attachment mechanism such as teeth 42″ or a through-card attachment mechanism such as a pin 42″), a magnetic attachment mechanism (not shown), and/or any attachment mechanism suitable for attaching the carrier 40 of the attachment component 30 to a personal card 22.

If an adhesive attachment mechanism 42 is used, it may have any of a variety of tack levels (e.g. low tack, medium tack, high tack, and super high tack). “Low tack” is temporary or extremely removable (e.g. like a POST-IT® note tack). “Super high tack” is essentially permanent. Most known index tabs are meant to be attached to paper or card stock. For example, an “index tab” with low tack adhesive may be temporarily attached to a document or page for quick reference. Other “index tabs” are permanently attached to dedicated paper or card stock dividers with super high tack adhesive. Certain embodiments of the present invention use semi-permanent adhesive (e.g. adhesives having medium tack adhesive and/or high tack adhesive). Exemplary semi-permanent adhesives include GLUE DOTS® low profile medium to high tack pressure sensitive adhesives from Glue Dots International of Germantown, Wis. (see the world wide web at gluedots.com) and/or 3M™ VHB™ Adhesive Transfer Tapes from 3M of St. Paul, Minn. (see the world wide web at 3M.com). The reason that semi-permanent adhesives work with the present invention is that most personal cards 22 are meant to last for significant periods of time and are, therefore, made from plastic or coated for durability. This makes it possible to use a semi-permanent adhesive that firmly adheres to the personal card surface so that it may be used for an extended period of time, but can be removed relatively easily (e.g. using a fingernail, rubbing the surface, or possibly using a mild solvent) if necessary or desired. It may be necessary or desirable to remove the multi-purpose auxiliary member 20 if, for example, the personal card 22 expires, if the card 22 is to be transferred to a compartment 26 with a different orientation, if the multi-purpose auxiliary member 20 becomes damaged, or for any other reason.

The length and width of the attachment component 30 is limited only by the size and shape of the personal card 22 as well as the orientation of the multipurpose auxiliary member 20. To maximize the flexibility of the multi-purpose auxiliary member 20 and the placement thereof, the attachment component 30 should be relatively small—being only large enough to make a satisfactory connection. (If the attachment component 30 is transparent, it will not visibly block any text upon which it is positioned). In certain embodiments, the attachment component 30 has the same width as or a narrower width than the extension component 32. Alternative embodiments have an attachment component 30 with a width wider than its associated extension component 32 where spatial constraints in the card carrying case permit. It should be noted that prior art index tabs that attach to paper or card stock use attachment components that have a width wider than their associated extension components 32 to avoid rips and/or tears to the paper or card stock which are generally not an issue to personal cards 22 to which multi-purpose auxiliary members 20 of the present invention are to be attached.

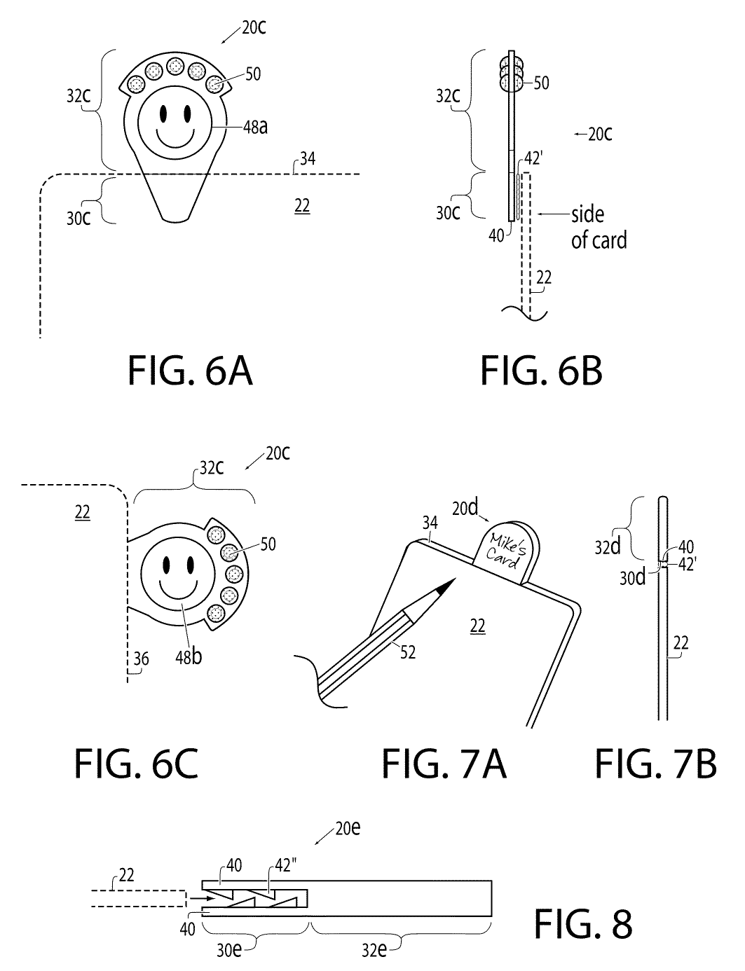

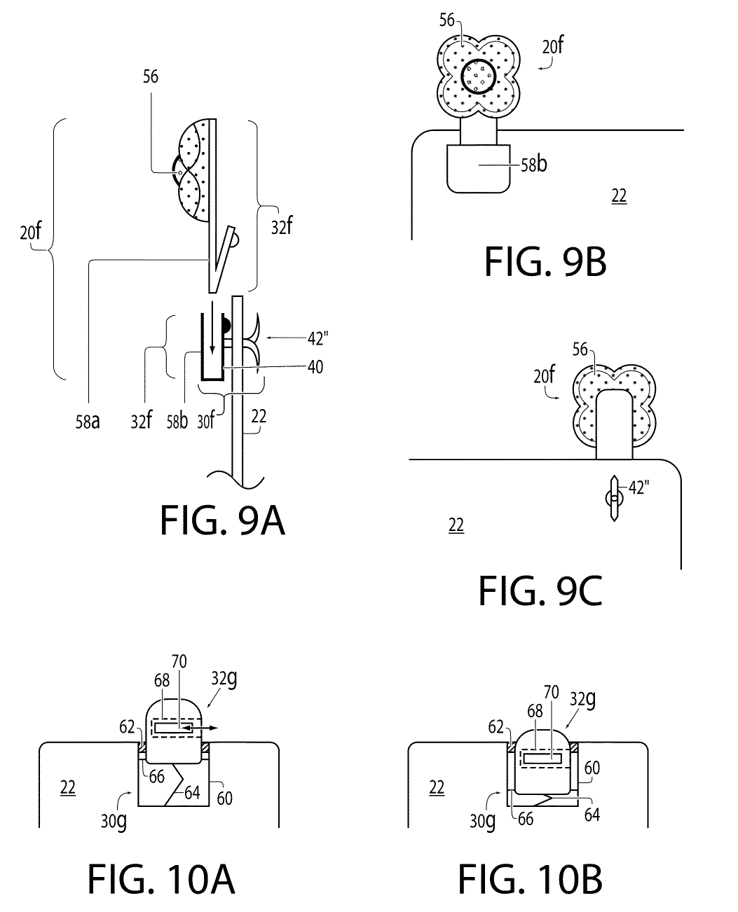

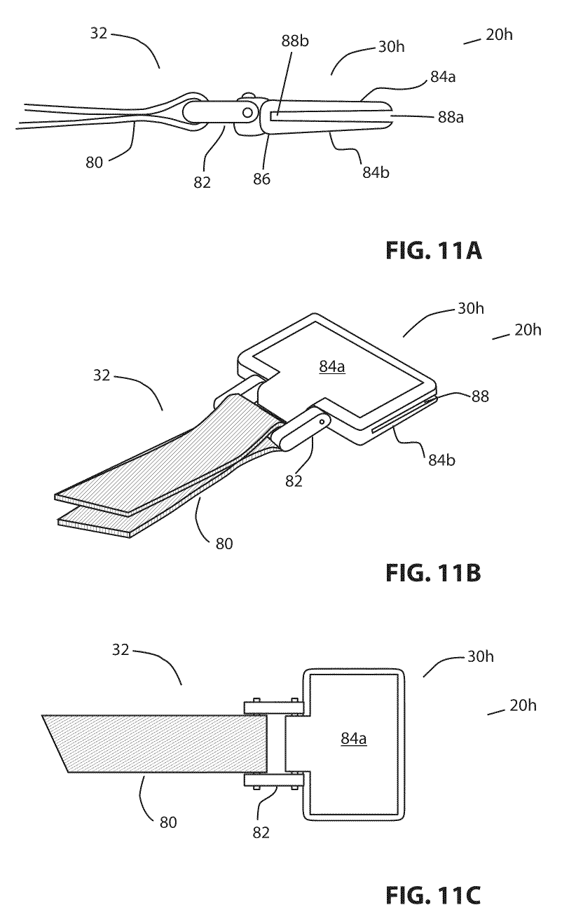

Exemplary embodiments of the attachment components 30 of exemplary multi-purpose auxiliary members 20 are discussed below in detail. Exemplary embodiments include, but are not limited to two attachment components 30a (one for each face of the card 22 to which it will attach) embodiment as shown in FIG. 4, an adjustable two-attachment component 30b embodiment as shown in FIGS. 5A-5C, a single narrow (shown as tapered inward) attachment component 30c as shown in FIGS. 6A-6C, an edge (where the carrier 40 is just an edge surface) attachment component 30d as shown in FIGS. 7A-7B, a mechanical gripping attachment component 30e as shown in FIG. 8, a mechanical through-card attachment component 30f as shown in FIGS. 9A-9C, a spring-loaded attachment component 30g as shown in FIGS. 10A-10B, and a tight friction attachment component 30h as shown in FIGS. 11-17. These examples are not meant to limit the scope of the invention.

### Extension Component 32

The extension component 32 may have many purposes including, but not limited to identification, gripping, advertising, adding technology, accessorizing (e.g. adding fashion to), providing a writing surface, and organization. In certain embodiments of the invention where the multi-purpose auxiliary member is a card removal tool, as shown in FIGS. 11-17 and described in more detail below, the primary purpose of the extension component 32 is to provide a means for gripping the multi-purpose auxiliary member and thereby indirectly gripping a personal card 22 to which the multi-purpose auxiliary member is attached. Such extension components may also be adapted for additional functions such as identification, advertising, accessorizing, organization and the like, provided the additional function(s) do not interfere with the primary purpose of gripping.

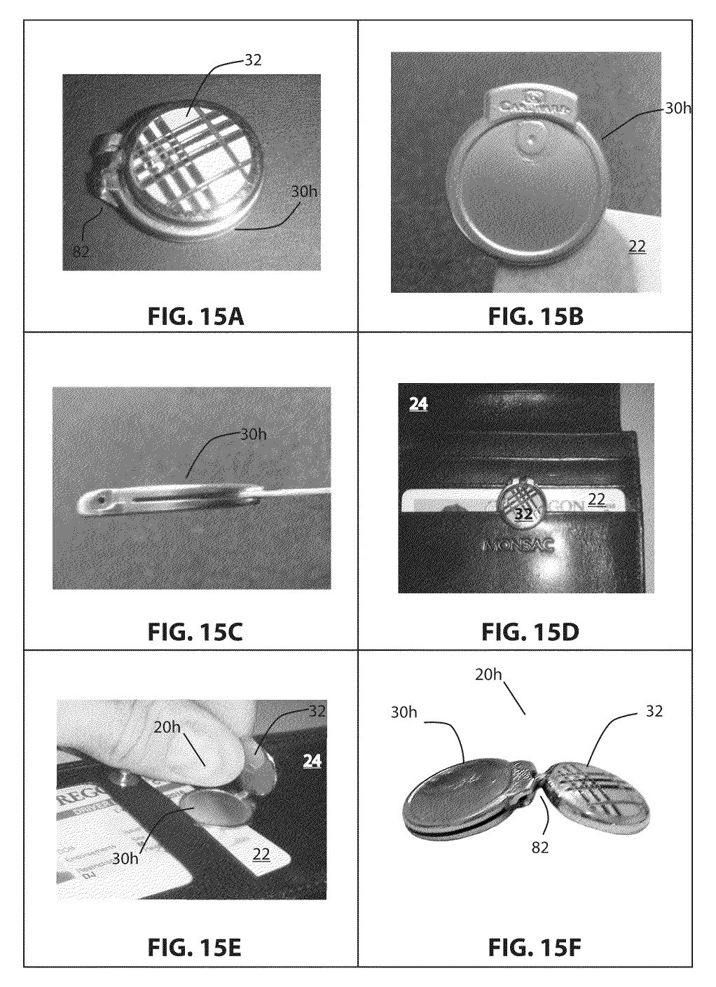

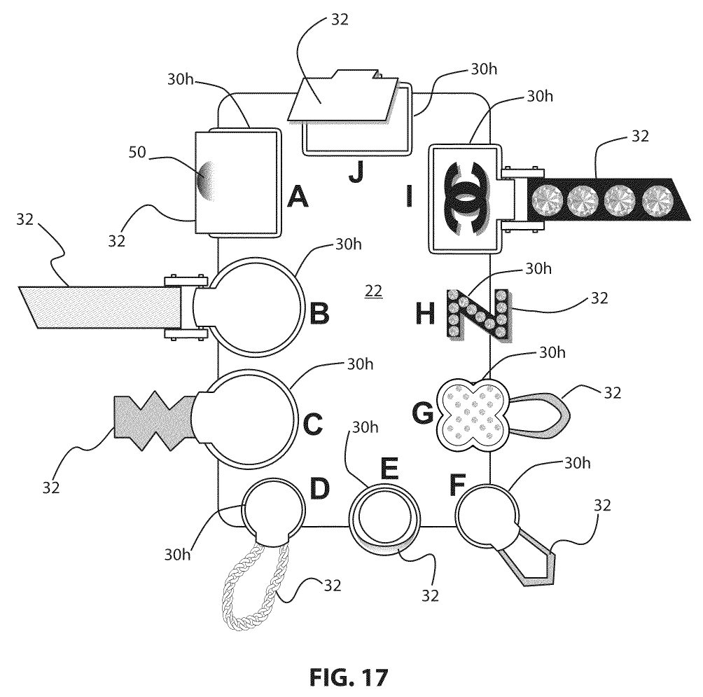

The gripping means 50 of the extension component 32 can be accomplished by providing, extending or increasing the size or surface area of the multi-purpose auxiliary member, e.g. where the extension component is a tab, chain, tie or other structure that extends beyond an annular edge of the personal card to which the multi-purpose auxiliary member. In certain embodiments, the gripping means 50 is a ridge or depression that can be accessed by a fingertip or fingernail to pull the multi-purpose auxiliary member and an attached card from a card carrying case (e.g., FIGS. 13A, 13B, 17A and 17E). In yet other embodiments, the gripping means 50 includes a shape or texture applied to the surface of the extension component that reduces slipping of the extension component when grasped between two fingers. In some aspects of the invention, where the extension component is hinged (e.g. FIGS. 15E and 15F) or otherwise can be moved relative to the attachment component (e.g. a chain, tie or strap), the gripping means can include the ability to apply leverage forces to remove the multi-purpose auxiliary member from a card carrying case. One aspect of a leverage feature of the gripping means can be seen in FIGS. 15D-15 F. In these figures, the extension component operates like a clamshell and can be folded from a closed position, parallel to the attachment component (FIG. 15D), to an approximately 90 degree angle to the attachment component (FIG. 15E). As illustrated in FIG. 15E, this permits pressure from a thumb or other finger to push the multi-purpose auxiliary member out of a slot of the card carrying case while optionally supporting the opposing side of the extension component with another finger. In certain embodiments, the clamshell can be opened more or less fully such that the extension and attachment components are at various angles to each other, such as 45 degrees, 120 degrees (FIG. 15 F) and 180 degrees. In other embodiments, the extension component opens to discrete positions or stops, such as at a 90 degree angle to the attachment component (FIG. 15E).

In certain embodiments, the extension component 32 may be printed, marked, or surfaced in any way to individualize the personal card 22 to which the multipurpose auxiliary members 20 have been attached. Individualizing each personal card 22 aids in the organization of the card carrying case 24 by enabling one to identify and locate each individual card 22 the moment the card carrying case 24 is opened.

The extension component 32 may be manufactured in a variety of sizes and shapes. For example, the extension component 32 can have a width of approximately ⅓ of the length of a standard personal card 22 so that three multipurpose auxiliary members 20 can be used on three separate cards 22 (one at the left side, one at the middle, and one on the right side) so that the extension components 32 will not overlap when the three cards are stacked together. Similarly, the extension component 32 can have a width of approximately 1/10 of the length of a standard personal card 22 so that ten multi-purpose auxiliary members 20 can be used on ten separate cards 22 (staggered) so that the extension components 32 will not overlap when the ten cards are stacked together.

In certain embodiments, the extension component 32 is of a minimal size to prevent interference with or add bulk to the card carrying case 24. In other embodiments, it may be desirable for the extension component 32 to be longer than the personal card 22. For example, the present invention contemplates that the extension component 32 can be a cord, strap, chain, or the like that is attached at one end to the attachment component 30 and at the other end, can be tied, clipped, fastened or otherwise removably or permanently fastened to the card carrying case 24, a handbag, an article of clothing or the like to tether the personal card 22 to the owner. Such embodiments can be used to prevent loss of the card due to theft or accidental misplacement. It is contemplated that such tethered embodiments will permit removal of the personal card 22 from a card carrying case 24 e.g. for inspection or swiping a magnetic stripe on the card, while retaining a connection or tether to the owner. Should the owner forget to replace the personal card 22 in the card carrying case 24, it would still remain attached to the owner or his belongings rather than becoming lost. The skilled artisan will understand that there are many situations and uses for such an adaptation of the extension component of the invention.

The multi-purpose auxiliary member 20 may be made of any material including, but not limited to paper (e.g. card stock and/or cardboard), plastic, velum, metal (e.g. precious metals or non-precious metals), leather, stone, wood, plastic, rubber, or any material or combination of materials that is stiff enough to stand upright in the small size discussed above. It should be noted that the intended use may influence the choice of material. For example, more durable materials would be required in applications in which durability is important (e.g. to attach to a card 22 that will be used often and for a long time) whereas inexpensive material may be used for applications where durability is unimportant (e.g. to attach to a card 22 that has a limited life, for example, a hotel key card). If the multi-purpose auxiliary member 20 is to be written on, the material chosen would have to be suitable for that purpose. In certain embodiments, such as those illustrated in FIGS. 11-17, the multi-purpose auxiliary member 20 is made of a strong, rigid and durable material such metal or plastic and has a primary purpose of attaching to a personal card 22 and facilitating removal of the personal card from the card carrying case 24. The present invention also contemplates that the multi-purpose auxiliary member 20 may be made of more than one material. For example, in one aspect of the invention, the multi-purpose auxiliary member 20, or the attachment component 30 thereof, may be made primarily or substantially of a strong, rigid and durable material such metal or plastic, but may also include decorative elements made from other materials such as leather, fabric, enamel, glass, crystal, gemstones, paper, cardboard and the like that may be less strong, rigid or durable. The extension components 32 of the multi-purpose auxiliary members of the invention may be even more varied in composition, including both flexible and rigid materials.

Although the multi-purpose auxiliary members 20 may be manufactured in a variety of shapes and sizes, in certain embodiments the extension component 32 extends beyond an outermost annular edge of the personal card 22 when the multi-purpose auxiliary members 20 is attached to the personal card 22. In one embodiment, extension component 32 extends beyond the outermost annular edge of the card 22 by approximately 0.2 inches (5 mm) to 0.5 inches (13 mm). In certain embodiments, the extension component 32 has a width of between 0.25 inches (7 mm) to 1.5 inches (38 mm), other embodiments of the extension component 32 have a width of approximately 0.5 inches (13 mm). It may be desirable to use a relatively thin (e.g. between 0.0007 inches (0.02 mm) and 0.0787 inches (2 mm)) material for the extension component 32. Using a relatively thin material for the extension component 32 is advantageous in that it does not add bulk to a personal card collection 22. It should be noted that in certain embodiments where the extension component 32 is positioned substantially above or to the side of the card 22, it can be thicker than the carrier 40 without adding bulk to a personal card collection 22.

Exemplary embodiments of the extension components 32 of exemplary multi-purpose auxiliary members 20 are discussed below in detail. Exemplary embodiments include, but are not limited to, a bent or bendable extension component 32a embodiment as shown in FIG. 4, a customizable (shown as a replaceable design object or technology device) extension component 32b embodiment as shown in FIGS. 5A-5C, a multi-orientation and three-dimensional extension component 32c as shown in FIGS. 6A-6C, a writable surface extension component 32d as shown in FIGS. 7A-7B, a thickset extension component 32e as shown in FIG. 8, a two-part extension component 32f as shown in FIGS. 9A-9C, and a retractable passaged extension component 32g as shown in FIGS. 10A-10B. A hinged extension component as shown in FIGS. 11A-11D. These examples are not meant to limit the scope of the invention.

### Exemplary Embodiments

The following paragraphs describe exemplary attachment components 30 of exemplary multi-purpose auxiliary members 20. These examples are not meant to limit the scope of the invention.

As shown in FIG. 4, a first embodiment of a multi-purpose auxiliary member 20a can be described as having two attachment components 30a (one for each face of the card 22 to which it will attach) and a bent or bendable extension component 32a. Because there are two attachment components 30a, this embodiment would be particularly securely attached to the card 22 as compared to a single attachment component embodiment using adhesive having the same tack. The attachment components 30a both include a carrier 40 and an adhesive attachment mechanism 42. The bent or bendable extension component 32a can be pre-bent or it can be bent by the user. The bend would be advantageous for viewing purposes, for example, in pouches 26a where there are a number of cards 22 upon which the user looks down. Although shown with an embossed design thereon (which provides a type of gripping surface), the extension component 32a could have, for example, a printed surface or a writable surface.

As shown in FIGS. 5A-5C, a second embodiment of a multipurpose auxiliary member 20b can be described as having an adjustable two-attachment component 30b and a customizable (shown as a design object or technology device) extension component 32b. This embodiment, when attached, has two attachment components 30b (one for each face of the card 22 to which it will attach). In this embodiment, the entire multi-purpose auxiliary member 20b may be a carrier 40 having an adhesive attachment mechanism 42. FIG. 5A shows a flat and pre-attached stage of the multi-purpose auxiliary member 20b. In this embodiment, the multi-purpose auxiliary member 20b has a perpendicular fold 44a at approximately the halfway point along its longitudinal length. There may also be at least one score or guide line 44b, 44c to assist the user in the positioning of the multi-purpose auxiliary member 20b. In the shown embodiment, there is a first score or guide line 44b (approximately midway between the fold 44a and an end of the multi-purpose auxiliary member 20b) and a second score or guide line 44c (approximately midway between the fold 44a and the first score or guide line 44b). Also shown in this embodiment is a design object or technology device 46a, 46b that may be replaceable. Technology devices are discussed below. Design objects may be, for example, charms, jewels, printed materials (e.g. a small card showing a name or logo), user customizable labels, or any other decorative or practical object of appropriate size. If a design object is used, the carrier 40 may be clear or transparent so that the design object may be seen therethrough. FIG. 5B shows the multi-purpose auxiliary member 20b positioned so that the second score or guide line 44c is aligned with the edge of a card 22. This alignment would make the extension component 32b relatively short and, therefore, suitable for use when there is not much clearance. FIG. 5C shows the multi-purpose auxiliary member 20b positioned so that the first score or guide line 44b is aligned with the edge of a card 22. This alignment would make the extension component 32b relatively long.

As shown in FIGS. 6A-6C, a third embodiment of a multipurpose auxiliary member 20c can be described as having a single narrow (shown as tapered inward) attachment component 30c and a multi-orientation and three-dimensional extension component 32c. This embodiment has only a single attachment component 30c (for attaching to a single face of the card 22 to which it will attach). In this embodiment, the attachment component 30c includes a carrier 40 (that may be at least partially coextensive with the extension component 32c) having an adhesive attachment mechanism 42. The shown exemplary adhesive mechanism 42 is a two-sided tape that may be a separate component (e.g. the attachment component 30c is sold with a carrier 40 that does not have adhesive, but the package comes with a two-sided tape that has backing paper on both sides and the user attaches it prior to use) or could be pre-attached on one side (e.g. the attachment component 30c is sold with a carrier 40 upon which one side of the two-sided tape is attached and the other side still has its backing paper that the user removes prior to attaching it to a card 22). FIGS. 6A and 6B also show another unique feature of the present invention in that there is a design element 48a, 48b (e.g. a logo and/or text) on both sides of the extension component 32c, but the design elements 48a, 48b have different orientations. For example, in FIG. 6A the design element 48a has a vertical orientation relative to a longitudinal axis of the extension component 32c, whereas in FIG. 6C the design element 48b has a horizontal (perpendicular) orientation relative to a longitudinal axis of the extension component 32c. This allows the user to choose an orientation depending on his particular card carrying case 24 and/or orientation preference. Another unique feature of the embodiment shown in FIGS. 6A-6B is that there is a gripping feature 50 (shown as a series of raised stones or jewels) on the extension component 32c. FIG. 6B shows that the gripping feature 50 may protrude from both sides of the extension component 32c. Alternatively, the gripping feature 50 may protrude from only a single side of the extension component 32c. It should be noted that the gripping feature 50 may be an embossing, molded into (or otherwise integral), attached to the surface, or otherwise provided so that the user has something to grip (e.g. to add friction or provide a ridge) to help him grip the extension component 32c.

As shown in FIGS. 7A-7B, a fourth embodiment of a multipurpose auxiliary member 20d can be described as having an edge attachment component 30d and a writable surface extension component 32d. An edge attachment component 30d is one in which the carrier 40 is an edge surface of the surface extension component 32d. This embodiment also shows an alternative adhesive 42′ that is a bead line of adhesive such as glue or epoxy. To install the multi-purpose auxiliary member 20d, the user would place the alternative adhesive 42′ edge surface of the surface extension component 32d (and/or along the edge surface of the card 22) and then bring the edge surface of the surface extension component 32d into contact with the edge surface of the card 22 so that the two edge surfaces are adhered together by the alternative adhesive 42′. In this embodiment, the extension component 32d has a writable surface that the user may write upon (e.g. using a writing instrument 52).

As shown in FIG. 8, a fifth embodiment of a multi-purpose auxiliary member 20e can be described as having a mechanical gripping attachment component 30e and a thickset extension component 32e. The mechanical gripping component 30e in this embodiment includes two leg carriers 40, each of which has at least one mechanical gripping attachment mechanism 42″ such as teeth, prongs, nubs, or any mechanism that would help hold the multi-purpose auxiliary member 20e to the card 22. Although not shown in this embodiment, the two leg carriers 40 can be angled towards each other. When the card 22 is inserted between the two leg carriers 40 that are angled towards each other, the card 22 forces apart the two leg carriers 40. The forced apart two leg carriers 40 then would provide inward pressure to help secure the card 22 therebetween. Further, although not shown in this embodiment, the mechanical gripping component 30e could also include at least one or more alternative mechanisms by which the two leg carriers 40 more securely grip the card 22. The thickset extension component 32e, in this case may be, for example, a metal charm. It also may enclose, encapsulate, and/or conceal a technology device and/or a design element. Still further, the thickset extension component 32e may have a passage (e.g. pocket or slot) at least partially therethrough such that the technology device and/or a design element may be insertable and/or removable.

As shown in FIGS. 9A-9C, a sixth embodiment of a multi-purpose auxiliary member 20f can be described as having a mechanical through-card attachment component 30f and a two-part extension component 32f. The two-part extension component 32f, as shown, includes a design object 56 (although it could include technology) and a latch 58a/socket 58b combination. The latch 58a and socket 58b allow the user to easily change the design object 56 (which is associated with the latch 58a. It should be noted that the latch 58a/socket 58b implementation is meant to be an exemplary implementation of a two-part extension component 32f. Accordingly, other two-part extension components 32f could be used including, but not limited to a magnetic two-part mechanism, hooks and eyes, or any other two-part mechanism. For example, the user could have a different jewel or charm for each day of the week or for each outfit. It should be noted that the latch 58a and socket 58b could also be described as being part of the attachment component 30f. The mechanical through-card attachment component 30f includes a carrier 40 (shown as the back of the socket 58b) and any through-card attachment mechanism 42″ (e.g. a pin, a rivet, and/or a brad) that is of sufficient length to pass through the card 22 and be secured. In the shown embodiment, the through-card attachment mechanism 42″ is a brad-like device with two prongs that are spread to secure the multi-purpose auxiliary member 20f to the card 22. It should be noted that the through-card attachment mechanism 42″ could be self-piercing (e.g. sharp so that it can pierce the card itself) or it could be used with pre-pierced cards (e.g. cards that already have holes therein either for the purpose of using the through-card attachment mechanism 42″ or for another reason (e.g. fob cards)).

As shown in FIGS. 10A-10B, a seventh embodiment of a multipurpose auxiliary member 20g can be described as having a spring-loaded attachment component 30g and a retractable passaged (e.g. pocket or slot) extension component 32g. FIG. 10A shows the multi-purpose auxiliary member 20g in an expanded position and FIG. 10B shows the multi-purpose auxiliary member 20g in a contracted position. The spring-loaded attachment component 30g, as shown, includes a three-sided sleeve 60 having a lip 62 on both sides of its open ends and a spring component 64 enclosed therein. The spring-loaded attachment component 30g (or the three-sided sleeve 60) may be attached to the card 22 (e.g. the back of the three-sided sleeve 60) a using any attachment mechanism (not shown). The retractable passaged extension component 32g has a catch 66 on both sides thereof, each catch 66 is designed to engage with the respective lips 62 when the multi-purpose auxiliary member 20g is in an expanded position (FIG. 10A). When pressure is applied to the retractable passaged extension component 32g, the spring component 64 is compressed so that the retractable passaged extension component 32g slides into the three-sided sleeve 60. Releasing the pressure causes the spring component 64 to expand so that the retractable passaged extension component 32g slides out of the three-sided sleeve 60, but the lips 62/catches 66 prevent the retractable passaged extension component 32g from escaping. The retractable passaged extension component 32g, as shown, includes a passage 68 at least partially therethrough. The passage 68 may be used to accommodate a writable element, a printable element, a technology device, and/or a design element (shown generally as item 70). It should be noted that this embodiment would be particularly useful in card carrying cases 24 having little clearance such that when a flap is closed (or a zipper is zipped), the retractable passaged extension component 32g contracts into the three-sided sleeve 60 and when the flap is opened (or the zipper is unzipped), the retractable passaged extension component 32g expands out of the three-sided sleeve 60. It also would be advantageous to use this embodiment to allow a card 22 to be slid through a scanner or inserted into a slot (e.g. at an ATM/bank machine or at a gas pump). It should be noted that by omitting the spring component 64 an alternative embodiment could be created. In this alternative embodiment the extension component 32g slides into the three-sided sleeve 60, but is not pushed back up. A finger grip, lever, dial, or other actuator could be used to manually slide the extension component 32g out of the three-sided sleeve 60. Other exemplary extensions are shown in FIGS. 1-3. For example, FIG. 3 shows an extension 30h with a cutout in which there is a through-hole through the extension that would allow a hook, string, or other attachment to be inserted therethrough. FIG. 3 also shows an extension 30i that has an embossed design thereon, an extension 30j that is long and narrow and has stones thereon, an extension 30k that is shaped metal, and an extension 30l that has a gripping surface thereon. Another example shown in FIGS. 1 and 2 is a “cutout” extension 30m in which the shape of the extension is not a traditional shape. It should be noted that any of the attachment components 30a-l could be used with any of the extension components 32a-f shown in this figure.

The skilled artisan will recognize that the exemplary attachment components and extension components described herein can be combined in various ways that are within the scope of the invention. In particular, any of the extension components can be used with the personal card removal tool embodiments of the multi-purpose auxiliary member described below.

### Personal Card Removal Tool Embodiments

In certain aspects of the invention, the multi-purpose auxiliary member 20 provides a personal card removal tool, shown generally as 20h. An exemplary personal card removal tool of the invention is shown in FIGS. 11A-11C. As shown in FIGS. 11A and 11B, the tool 20h includes an attachment component 30 and an extension component 32. The attachment component according to this embodiment, is a generally flattened, rigid, U-shaped body, the attachment component including a planar top gripping arm 84a and a planar bottom gripping arm 84b roughly parallel to the top gripping arm, each arm disposed upon and extending distally from a common base 86, the top and bottom gripping arms defining a card slot 88 that is adapted to accept a personal card 22, the card slot having an open front end 88a and closed back end 88b that terminates at the base 86. Attachment components according to this embodiment of the invention are shown generally as 30h and are typically formed as a single, continuous unit that is not bendable and is unbreakable or is resistant to breakage. However, such attachment components can be made of separate parts that are joined together (e.g. welded or fused), provided the top and bottom gripping arms 84a and 84b are held in a fixed position relative to each other, thereby defining a card slot 88 that can accept and retain a personal card 22 by a tight friction fit with manual force applied to the card as it is inserted into the card slot 88.

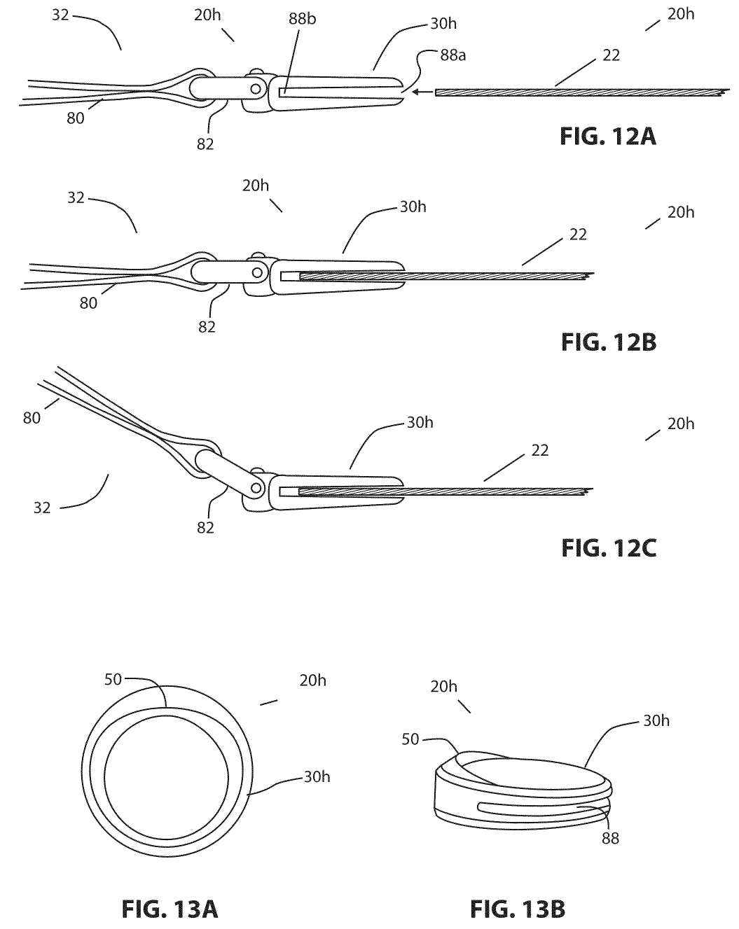

In certain aspects of the invention, the card slot 88 includes a taper, such as a continuous taper, having a wide opening 88a and terminating in a narrower region 88b at the base of the attachment component 86. In use, a personal card 22 is inserted into the wide opening 88a of the card slot 88 and pushed toward the narrower base region 88b, as illustrated in FIGS. 12A and 12B. The arrow in FIG. 12A shows the direction of insertion of personal card 22 into card slot 88. A tight friction fit is obtained when the personal card 22 is seated within the card slot 88 at a point where the taper is approximately equal to or less than the nominal thickness of the personal card 22. With the tight friction fit on the personal card 22, the tool 20h can be used to insert the personal card 22 into a card carrying case 24 while remaining attached to the personal card 22. Similarly, a tool 20h attached to a personal card 22 while the personal card is retained a compartment 26 of a card carrying case 24 can be used to remove the personal card 22 from the card carrying case. Moreover, the tool 20h can to be used to grasp and remove a card that is secured in a compartment 26 of a card carrying case 24. Accordingly, the tool 20h is adapted to fit snugly on the a personal card 22 such that only moderate force is required to insert the card into the tool or remove the card from the tool, while the tight friction fitted tool-card assembly can be removed from a slot or other compartment 26 of a card carrying 24 case using the tool 20h as a grasping surface or handle, without displacing the personal card 22 from the tool.

In certain embodiments of the invention, the inner surfaces of the card slot 88 may be contoured and/or include patterns, textures or impressions made during fabrication. For example, the slot 88 may contain teeth or ridges, baffles, an etched surface or the like. Such contours and textures can provide a non-slip surface suitable to improving the fit of the personal card 22 within the card slot 88. In some embodiments, certain contours of the tool are machined after molding or applied to the molded tool body, such as by spraying or coating. For example, the card slot 88 may be lined or coated with a resilient or slip-resistant material, such as silicone rubber or plastic to prevent slippage of a personal card 22 within the card slot 88. When present, the lining or coating on the fitting port maybe applied by any available method, such as by spraying or painting. Alternatively, a pre-formed sleeve of suitable material may be inserted into and/or adhered to the inner surface of a card slot 88.

With reference to FIG. 11A, card slot 88 has a width of about 0.40 mm to about 1.00 mm at the front opening 88a and tapers to a width of about 0.30 mm to about 0.90 mm at back 88b of the card slot. In certain embodiments, the card slot 88 is between about 0.30 mm and about 1.00 mm wide, and is adapted to fit cards having a thickness of about 0.45 mm to about 0.76 mm. In other embodiments, the card slot 88 is between 0.40 mm and 0.55 mm wide, and is adapted to fit cards having a thickness of about 0.45 mm to about 0.50 mm. In yet other embodiments, the card slot 88 is between about 0.50 mm and about 0.80 mm wide, and is adapted to fit cards having a thickness of about 0.55 mm to about 0.75 mm.

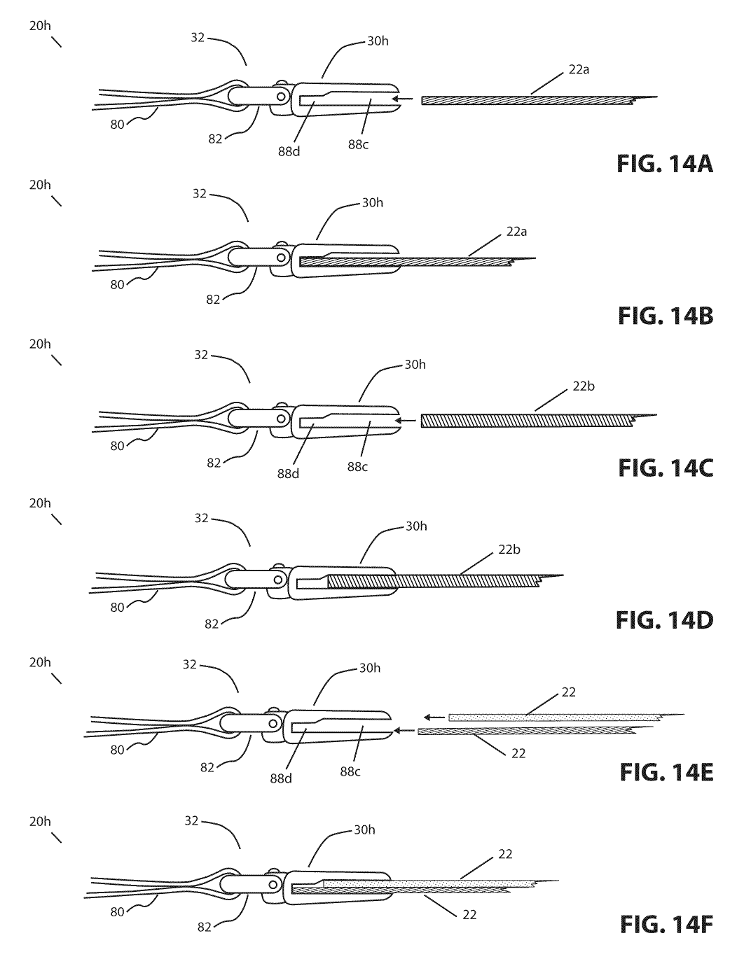

In other embodiments, the card slot 88 can be stepped instead of continuously tapered as illustrated in FIGS. 14A-14D. Such card slots include two or more discrete regions, each adapted to accept a particular personal card thickness. In the exemplary embodiment shown in FIGS. 14A-14D, the card slot 88 of tool 20h includes a wide terminal region 88c adjacent to the front opening of the card slot and a narrow proximal region 88d adjacent to the back of the card slot. The wide terminal region 88c is of sufficient width to accept thick personal cards 22b while the narrow proximal region is of sufficient width to accept only thinner personal cards 22a. Thus, tools according to such embodiments can be used with cards of different thicknesses. In certain aspects, both the wide terminal region 88c and the narrow proximal region 88d of the card slot 88 are tapered from front to back to accommodate nominal variations in the thickness of various personal card inserted therewithin. In certain aspect, the narrow proximal region is about 0.3 mm to about 1.00 mm wide, and the wide terminal region is about 0.6 mm to about 1.6 mm wide.

The attachment component can be made of any durable, rigid material, such as metal, metal alloy or plastic (e.g. PVC, polycarbonate, or polystyrene). More particularly, attachment component 30h is constructed such that the upper and lower arms (84a and 84b, respectively) remain in a fixed position relative to each other when a personal card 22 is inserted into the card slot 88. When metal is used, care must be taken to avoid metals that are susceptible to bending or otherwise deforming at temperatures likely to be encountered during use.

The attachment component 30h can be made by any suitable process including but not limited to, molding, casting, forging, laminating, carving, machining, pressing, fabricating and the like. In one embodiment, the tool is made by injection molding of plastic. In certain embodiments of the invention, the attachment component 30h is formed as a single piece of plastic. In other embodiments, two or more pieces of plastic are manufactured and the parts assembled (e.g. bonded) to form the attachment component. In other embodiments, the attachment component 30h is formed as a single piece of metal or metal alloy. In other embodiments, two or more pieces of metal are manufactured and the parts assembled (e.g. soldered or welded) to form the attachment component. In yet other embodiments, the overall shape of the attachment component 30h is manufactured and then card slot 88 is formed e.g. by cutting, carving, drilling, sawing or the like.

In one particular aspect of the invention, the attachment component is made by the process of metal injection molding. “Metal injection molding” or “MIM” combines the versatility of plastic injection molding with the strength and integrity of machined, pressed or otherwise manufactured small, complex, metal parts. According to this process, fine metal powders are mixed with plastic binders. The mixture is then heated to form a flowable liquid or suspension that can be injected into a mold using equipment similar to standard plastic injection molds and machines. After cooling, the parts are ejected from the molds and the plastic binders are removed with solvents and/or heat. The remaining metal parts are then sintered at a temperature that binds but does not melt the metal, resulting in a product that is up to 98% as dense as wrought metal. Using this process, attachment components having small overall thicknesses as well as both upper and lower arms that are that are thin and precisely positioned above and below e.g. a tapered card slot 88 can be achieved.

The overall size and shape of the attachment component can be varied considerably as described above, including round, elliptical, square, rectangular, and free-form shapes of various sizes. In certain embodiments, the attachment component will have a decorative shape, such as a flower or a letter of the alphabet. In other embodiments, the decorative shape will be figural or represent a particular brand.

The attachment component 30h of tool 20h is typically between about 10 mm and 40 mm wide, between 10 mm and 40 mm long, and has a maximal thickness of about 2 mm to about 10 mm. Each arm of the attachment component is preferably as thin as it is possible to manufacture while retaining the rigidity of the attachment component arms. The skilled artisan will appreciate that the nominal thickness of a material will, in part, dictate flexibility and rigidity of an article at ambient temperatures. For example, while aluminum foil is flexible, thick parts of aluminum articles are more rigid, although steel and other metals are more rigid at comparable thickness. In general the attachment component arms 84a and 84b will retain their shape and position relative to each other through repeated insertion of personal cards 22 into the card slot 88, without bending or breaking Each arm will typically have a thickness in the range of about 0.1 mm to about 10 mm thick, frequently about 0.2.5 mm to about 5 mm thick, and often about 0.5 mm to about 2 mm thick. It will be well known the art that the thickness of the arms will be at least partially dependent on the material used and the manufacturing method employed. Metal injection molding permits manufacturing of precisely thin and complex metal parts and is therefore a suitable method for making the attachment component.

The attachment component can include additional materials and design elements such as plating, coating, painting, enameling, engraving, jewelling, and the like, provided the functionality of the tool is preserved. In some aspects of the invention, the size and shape will be limited by the geometry of the card carrying 24 case the personal card 22 will be held in. In applications where the card will be placed in a slot or specialized compartment of a wallet or billfold, a thinner attachment component may be desirable. Tools that include a variety of non-limiting examples of attachment component shapes contemplated by the present invention are illustrated in FIGS. 17A-17J.

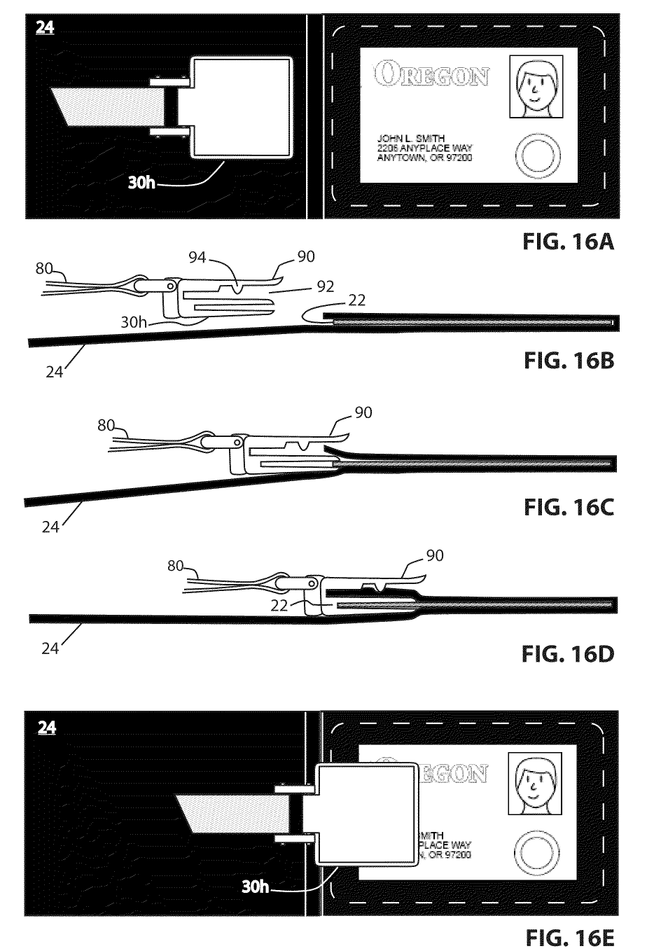

Optionally, the attachment components 30h of the tools 20h of the invention can also include additional elements adapted for end use. For example, the attachment component illustrated in FIGS. 16A-16E includes an additional arm 90 and slot adapted to receive a section of the card carrying case into which a personal card 22 is inserted. Such additional arms act as an anti-theft and anti-loss mechanism by preventing the card from accidentally falling out of the wallet or being removed from the wallet by an unwanted third party. As shown in FIG. 16B, the arm defines a slot 92 adapted to receive a section of e.g. a leather sleeve of a personal card case 24, and can include a ridge or baffle 94 that helps secure the tool and personal card 22 in the card carrying case 24. When inserting a personal card 22 that is contained in a card carrying case, the arm 90 slides over the section of the card carrying case holding the personal card. When properly seated, the ridge 94 on arm 90 pinches the leather to prevent unwanted displacement of the tool and card.

In certain embodiments, the attachment component 30h of the tool 20h of the invention may include two or more card slots 88. According to such embodiments, each card slot 88 is adapted to simultaneously receive a single personal card 22. The two or more card slots may be used to hold personal cards 22 that are frequently removed from a card carrying case 24 at the same time, such as a credit card and an identity card. When a tool 20h containing both cards is removed from a personal card case 24, both cards 22 are simultaneously removed with the tool. The two or more card slots 88 can each terminate at the same position in the base of the attachment component, or they can have staggered ends. When the base positions are staggered, an area of each of two or more personal cards 22 remains visible when the two or more cards are secured in the card slots 88. When the card slots 88 terminate at the same position, one card will be hidden behind the other card.

In one aspect, the two or more card slots 88 are each defined by an upper arm 84a and a lower arm 84b. In other embodiments the upper arm of one card slot is contiguous or coextensive with and thereby serves as the lower arm of another card slot. In other embodiments, the card slots are incomplete, as shown in FIGS. 14E and 14F. In yet further embodiments, the card slots share a common separator that does not satisfy the rigidity requirement of an arm of the invention, but is merely a spacer between the cards that may be flexible and/or thinner than the respective upper and lower arms.

The extension components 32 of the card removal tools 20h of the invention are adapted to provide an expanded, grippable surface or feature 50 that can be grasped and/or pulled to facilitate removal of an attached personal card 22 from a card carrying case 24. Thus, in certain embodiments, the extension component 32 provides a “handle” that can more easily be located and pinched, grasped or tugged with finger(s).

A wide variety of shapes and materials can be used for the extension component 32, including, but not limited to, metal, wood, plastic, leather and the like. Exemplary extension components are shown in FIGS. 17 A-J. In certain embodiments, the extension component is fused or bonded directly to the attachment component as shown in FIGS. 17A, 17C-17H. Such extension components are particularly suited to tools having a decorative shape where the extension component continues the decorative shape of the attachment component as illustrated by the “Z” shaped tool of FIG. 17H. In other embodiments, the extension component includes a hinge or flexible connector that allows the extension component to be moved or folded away from attachment component, as illustrated in FIGS. 17B, 171, and 17J. The ability to manipulate the extension component to different positions may provide additional leverage in removing the personal card 22 from a card carrying case, as illustrated in FIG. 15E. In yet further embodiments, the extension component is disposed directly upon or is an integral part of the attachment component. For example, the extension component can be a ridge or tab disposed on the top of the attachment component as shown in FIGS. 13A-B, and 17E. Such ridges permit the tool to be grasped and pulled with a fingertip. In certain aspects, the extension component includes a depression or “fingernail pick” area gripping means 50 adapted for insertion of a finger or fingernail to grip the tool and remove it from a card carrying case 24 as shown in FIG. 17A. In other embodiments, the extension component is a strap, chain or other loop into which a finger can be inserted, as shown in FIGS. 17D, 17F and 17G.

### Technology

The present invention may also include technology associated (e.g. added or attached) to a personal card 22. For example, a multi-purpose auxiliary member 20 having technology on or in it could be associated with the personal card 22. This would make it possible to add technology not present in the original personal card 22. This would also make it possible to increase the amount of information stored on the original personal card 22 by permanently or semi-permanently attaching at least one multipurpose auxiliary member 20 thereon.

The technology may be an electronic device, such as an integrated circuit (IC) device, a radio frequency device (e.g. radio frequency interface device (RFID)), or any electronic technology device known or yet to be discovered that can be programmed and/or has storage capabilities (e.g. memory). In one embodiment, the technology is a barcode that, by its specific pattern of stripes, “stores” information therein. One example of technology that may be associated with the multi-purpose auxiliary member 20 is a technology device that is programmed so that it can increase, change, limit, and/or restrict the personal card's 22 capabilities. For example, a standard loyalty card with a multi-purpose auxiliary member 20 having technology in it could have special and/or customized promotions associated with it. Another example of technology that may be associated with the multi-purpose auxiliary member 20 is a technology device that is programmed to act as (substitute for) a personal card 22. This would allow the user to decrease the number of personal cards 22 carried in his card carrying case 24 by allowing multiple multipurpose auxiliary members 20 to be attached to a single card 22. Each of the multipurpose auxiliary members 20 represents a substitute for the removed personal card(s) 22 taken out of the card carrying case 24. For example, rather than an employer providing separate access cards for different designated areas (e.g. zones, buildings, rooms, or filing cabinets), the employer could provide a single access card and three multiple multi-purpose auxiliary members 20 each of which can be read (e.g. swiped or scanned) for access into designated areas.

Yet another example of technology that may be associated with the multipurpose auxiliary member 20 is a technology device that is programmed to collect transactional information about transactions (e.g. purchases made at points of sale) made with a card 22 sporting a multi-purpose auxiliary member 20. The transactional information can be automatically downloaded or transmitted to a centralized data base or the transactional information can be downloaded or transmitted by a user to his personal secure data base (e.g. on a home computer). The transactional information can be compiled to provide, for example, tracking information on purchases for comparison against invoices provided by the card providers. The transactional information for multiple cards 22 can be compiled to provide a universal tracking system that, for example, provides a more complete indication of the user's spending habits. A user's spending habits are usually hard to determine when spending is spread over multiple cards 22. Using this universal tracking system, a service could be implemented in which a service provider prepares a single invoice and presents it to the user, the user pays the service provider's invoice, and the service provider then pays the card providers. Yet another example of technology that may be associated with the multipurpose auxiliary member 20 is a technology device that is programmed to act as a separate and/or universal award system. The separate and/or universal award system could be used in a system that tracks usage of different types of cards 22. The user could receive “rewards” such as points which can be converted to prizes, charitable donations, and/or any other valuable consideration. Usage information could be used for research, for customized advertising, and/or for any other purpose. The user would get rewards for allowing his usage to be tracked. Yet another example of technology that may be associated with the multi-purpose auxiliary member 20 is a technology device that is programmed to send a low level signal (i.e. act as a transmitter) to indicate its presence. A receiver technology element could be associated with the card carrying case 24. The receiver technology element could have means for receiving the low level signals, means for determining whether all the low level signals that are supposed to be received are being received, and means for notifying the user if a low level signal is not being received so that the user is made aware of the absence of the multi-purpose auxiliary member 20 and its associated card. The receiver technology could be programmable by the user and could have means for alerting the user (e.g. an audible alarm, a visual alarm, or a vibratory alarm). The receiver technology element could be integrated in the card carrying case 24 or it could be carried therein (e.g. in the form of a personal card 22 or in the form of a multi-purpose auxiliary member 20). This feature would be of value for users who tend to lose their cards 22 by leaving it, for example, with a cashier.

Yet another example of technology that may be associated with the multi-purpose auxiliary member 20 is a technology device that is programmed to receive a signal (i.e. act as a receiver) and provide a means for alerting the user (e.g. an audible alarm, a visual alarm, or a vibratory alarm) of its location. A transmitter technology element (that may be a standalone device or associated with another device (e.g. a cell phone)) could be used to send a signal that is to be received by the receiver multi-purpose auxiliary member. When the transmitter technology was activated, the receiver associated with the multi-purpose auxiliary member 20 would be activated which, in turn, would activate the means for alerting the user. A technology intensive implementation of this embodiment could also include a viewing screen on the transmitter technology element that would provide a map showing the location of the multi-purpose auxiliary members 20. Thus, this feature would be of value for users who tend to lose their cards 22 (e.g. in the house, in the car, etc.).

### Auxiliary Member System

Among other purposes of multi-purpose auxiliary members 20, when used together, they provide a system for easily organizing and categorizing multiple cards 22 because the multi-purpose auxiliary members 20 allow the user to distinguish one card 22 from another without moving (e.g. pulling them slightly out) or removing the cards 22 from the card carrying case 24. In embodiments, the auxiliary member system includes a plurality of multi-purpose auxiliary members 20, each associated with a personal card 22 in a personal card collection stored within a card carrying case 24 (which may be further divided into compartments 26). In certain aspects of the invention, the multi-purpose auxiliary members 20 are physically exposed when the personal cards 22 are placed within the compartments 26. The user can identify specific cards 22 based on the unique identifying multi-purpose auxiliary member 20 attached thereto without moving or removing the multitude of other cards 22 in the card carrying case 24.

As shown in FIGS. 1-3, the user may position the multi-purpose auxiliary members 20 on the cards 22 such that when the cards 22 are held in the card carrying case 24, the multi-purpose auxiliary members 20 are staggered. For example, in FIG. 1, the front first card 22 has a multi-purpose auxiliary member 20 positioned substantially at the extreme left of the card 22, the second card 22 has a multi-purpose auxiliary member 20 positioned enough to the right such that it is not blocked by the multi-purpose auxiliary member 20 on the front card, the third card 22 has a multi-purpose auxiliary member 20 positioned enough to the right such that it is not blocked by the multi-purpose auxiliary member 20 on the second card, and so on. If the user 15 changes the positioning and/or order of the cards 22, some embodiments of the multi-purpose auxiliary members 20 of the present invention are removable and/or replaceable.

It should be noted that there are several of unique features about the auxiliary member system as compared to typical indexing systems, some of which are elaborated herein. First, the cards 22 are not physically attached to each other or to a device common with another personal card (e.g. a holder such the binding of a notebook or the turnstile of a ROLODEX™). This lack of physical attachment can be described as “isolated” or “stand-alone.” In most indexing systems (e.g. a notebook with index tabs or a ROLODEX™-type system) the pages or cards are attached to the holder. Second, although most indexing systems are relatively private (i.e. only viewed by a single person or by a select group of people), the present invention is constantly being displayed to and/or handled by a wide variety of people. This feature makes having unique and/or decorative multi-purpose auxiliary members 20 particularly advantageous. The decorative aspect also allows a card 22 to be easily identified from a distance (e.g. from a group of cards used to pay a bill or when a gas station attendant takes a card to swipe it at a pump).

Third, as discussed above, there are advantages to being able to add technology to an auxiliary member system.

### Purposes and Advantages of Preferred Embodiments

In one embodiment of the present invention, a first purpose of the multi-purpose auxiliary member is to provide a means for distinguishing (identifying) one personal card 22 from another personal card 22 without moving (e.g. pulling them slightly out) or removing them from the carrying case or compartments 26 thereof.

In one embodiment of the present invention, a second purpose of the multi-purpose auxiliary member is to provide a means for easily removing a personal card 22 from a compartment 26 of a card carrying case 24. This may be accomplished by providing a surface that is graspable (e.g. the extension component 32 itself) by the user's fingers.

In one embodiment of the present invention, a third purpose of the multi-purpose auxiliary member is to provide a means for overcoming finger and/or fingernail slippage on the surface (face and/or edge) of a personal card 22. This may be accomplished, for example, by an additional gripping feature permanently or semi-20 permanently attached to the extension component 32, the gripping feature providing a ridge and/or enhanced traction.

In one embodiment of the present invention, a fourth purpose of the multi-purpose auxiliary member is to provide a means for adding an additional level of advertising to a personal card 22. This would be advantageous to companies who wanted to distinguish certain personal cards 20 in a user's card carrying case 24.

In one embodiment of the present invention, a fifth purpose of the multi-purpose auxiliary member is to provide a means for adding technology to a personal card 22.

In one embodiment of the present invention, a sixth purpose of the multi-purpose auxiliary member is to provide a means for reducing the number of cards carried by a user. This can be done by associating multiple multi-purpose auxiliary members 20 with a single card 22. For example, rather than an insurance company providing separate cards for medical, dental, and prescription benefits, the insurance company could provide a single card and three multiple multi-purpose auxiliary members 20 (one each for medical, dental, and prescription benefits).

Reducing the number of cards helps with card carrying case thickness constraints (e.g. in men's card carrying cases that are carried in a hip pocket so that the thickness of the card carrying case is important) and the limited number of pouches, pockets, and/or slots in which cards can be stored.

In one embodiment of the present invention, a seventh purpose of the auxiliary member system is to provide a means for easily organizing and categorizing multiple cards 22 in a card carrying case 24.

It should be noted that any one of or any combination of these purposes may be accomplished using a multi-purpose auxiliary member 20 and/or an auxiliary member 20 system of the present invention.

### Miscellaneous

It should be noted that the present invention may be used with personal cards or other items carried in a wallet (e.g. fob cards and keys). It should be noted that relative terms are meant to help in the understanding of the technology and are not meant to limit the scope of the invention.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. A multi-purpose auxiliary member tool for removing a personal card from a card carrying case comprising:
a) an attachment component, wherein the attachment component is a generally flattened body having a generally planar top card gripping arm and a generally planar bottom card gripping arm extending distally from a common base such that the top gripping arm and the bottom gripping arm are opposed and held in a generally parallel orientation to each other, said top gripping arm and said bottom gripping arm together defining a card slot having an open front end and closed back end, the card slot being adapted to removably accept and secure a personal card by tight friction fit; and
b) an extension component disposed upon and extending distally from the base of the attachment component, said extension component being adapted for gripping and removal a personal card from a card carrying case when the tool is secured to the personal card.

2. The multi-purpose auxiliary member tool according to claim 1, wherein the attachment component consists of a single unit that is made of rigid metal, plastic or a combination of metal and plastic.

3. The multi-purpose auxiliary member tool according to claim 2, wherein the attachment component is manufactured by metal injection molding.

4. The multi-purpose auxiliary member tool according to claim 1, wherein the back end of the card slot is narrower than the front end of the card slot, the card slot being tapered from back to front.

5. The multi-purpose auxiliary member tool according to claim 4, wherein the back end of the card slot is about 0.30 mm to about 0.90 mm wide and the front end of the card slot is about 0.40 mm to about 1.00 mm wide.

6. The multi-purpose auxiliary member tool according to claim 1, wherein the card slot is stepped, having a narrower region adjacent to the back end that is adapted to secure a thin personal card, and a wider region adjacent to the front opening that is adapted to secure a thick personal card.

7. The multi-purpose auxiliary member tool according to claim 6, wherein the narrower region of the card slot is about 0.30 mm to about 0.55 mm wide and the wider region of the card slot is about 0.55 mm to about 0.80 mm wide.

8. The multi-purpose auxiliary member tool according to claim 1, wherein the top gripping arm and bottom gripping arm are generally rectangular or circular in shape.

9. The multi-purpose auxiliary member tool according to claim 1, wherein the extension component is hingeably attached to the base of the attachment component.

10. The multi-purpose auxiliary member tool according of claim 9, wherein the extension component is adapted to rotate about the hinge from a closed position in which the extension component lies flat upon the attachment component, to an open position wherein the extension component is perpendicular to the closed position.

11. The multi-purpose auxiliary member tool according to claim 1, wherein the extension component is immovably attached to the base of attachment component.

12. The multi-purpose auxiliary member tool according to claim 11, wherein the extension component comprises a ridge disposed on an outer surface of the attachment component.

13. The multi-purpose auxiliary member tool according to claim 11, wherein the extension component is a continuation of a design element of the attachment component.

14. The multi-purpose auxiliary member tool according to claim 1, wherein the extension component comprises metal, leather, plastic, or glass.

15. The multi-purpose auxiliary member tool according to claim 14, wherein the extension component further comprises a decoration selected from paint, enamel, embossing, engraving or a stone.

16. The multi-purpose auxiliary member tool according to claim 1, wherein the attachment component further comprises a third arm adapted to secure the tool in a card carrying case.

17. The multi-purpose auxiliary member tool according to claim 1, further comprising at least one of: a magnetic stripe, a semiconductor chip device, an integrated circuit device, a radio frequency identification tag device or a bar code.

18. A multi-purpose auxiliary member tool for securing and removing at least two personal cards from a card carrying case comprising:
a) an attachment component, wherein the attachment component is a generally flattened body having at least one generally planar top card gripping arm and at least one generally planar bottom card gripping arm, each card gripping arm extending distally from a common base such that the at least one top card gripping arm and the at least one bottom card gripping arm are opposed and held in a generally parallel orientation to each other, said at least one top gripping arm and said at least one bottom gripping arm together defining at least two card slots each card slot having an open front end and a closed back end, the at least two card slots being adapted to removably accept and secure a personal card by tight friction fit; and
b) an extension component disposed upon and extending distally from the base of the attachment component, said extension component being adapted for gripping and removal of the at least two personal cards from a card carrying case when the tool is secured to the at least two personal cards.

19. The multi-purpose auxiliary member tool according to claim 18, wherein the multi-purpose auxiliary member tool comprises a first card slot and a second card slot, wherein the bottom card gripping arm of the first card slot is coextensive with the top card gripping arm of the second card slot.

20. The multi-purpose auxiliary member tool according to claim 18, wherein the at least two card slots are staggered.
